(19) United States
(12) Patent Application Publication
(10) Pub. No.: US 2012/0168987 A1
(43) Pub. Date: Jul. 5, 2012

(54) Method For Producing Preparations Of Substances With Low Solubility In Water

(75) Inventors: Karl Kolter, Limburgerhof (DE); Dejan Djuric, Mannheim (DE); Stefan Fischer, Freinsheim (DE)

(73) Assignee: BASF SE, Ludwigshafen (DE)

(21) Appl. No.: 13/496,712

(22) PCT Filed: Sep. 7, 2010
(86) PCT No.: PCT/EP10/63090

§ 371 Date: Mar. 16, 2012

(30) Foreign Application Priority Data
Sep. 18, 2009 (EP) 09170695.2

(51) Int. Cl. B29C 45/76

(52) U.S. Cl. 264/328.6

(57) ABSTRACT

A process for producing moldings from formulations of sparingly water-soluble active ingredients, the active ingredients having been embedded in amphiphilic copolymers, which comprises shaping the formulations by injection-molding a melt of the formulations, the mold temperature of the melt being 40 to 180° C.

The present invention relates to a process for producing moldings for administration forms based on formulations of sparingly water-soluble active ingredients, in which the active ingredients have been embedded in amphiphilic copolymers.

The embedding is effected by extrusion and preferably at temperatures above the melting point of the sparingly water-soluble substances, the substances being present in amorphous form in the extruded formulation. The embedding can also be effected at temperatures below the melting point of the sparingly soluble active ingredient.

The corresponding copolymers are suitable as solubilizers for the sparingly water-soluble substances.

In the production of homogeneous formulations, especially of biologically active substances, the solubilization of hydrophobic, i.e. sparingly water-soluble, substances has gained very great practical significance.

Solubilization is understood to mean the solubilizing of substances which are sparingly soluble or insoluble in a particular solvent, especially water, by interface-active compounds, the solubilizers. Such solubilizers are capable of converting sparingly water-soluble or water-insoluble substances to clear, at most opalescent aqueous solutions, without the chemical structure of these substances undergoing any change in the process.

WO 2007/051743 discloses the use of water-soluble or water-dispersible copolymers of N-vinyllactam, vinyl acetate and polyethers as solubilizers for pharmaceutical, cosmetic, food technology, agrochemical or other industrial applications. It is described in quite general terms therein that the corresponding graft polymers can also be processed with the active ingredients in the melt.

WO 2009/013202 discloses that such graft polymers of N-vinyllactam, vinyl acetate and polyethers can be melted in an extruder and mixed with pulverulent or liquid active ingredients, the extrusion being described at temperatures significantly below the melting point of the active ingredient.

What is described is typically the production of granules which can then be pressed to tablets. However, according to the composition, such granules are not always easy to press. Moreover, the variety of forms of the pressed tablets is limited.

It was an object of the present invention to enable an improved process for processing sparingly water-soluble active ingredients in a formulation with improved solubility to moldings.

Accordingly, a process has been found for producing moldings from formulations of sparingly water-soluble active ingredients, the active ingredients having been embedded in amphiphilic copolymers, which comprises shaping the formulations by injection-molding a melt of the formulations, the mold temperature of the melt being 40 to 180° C.

Suitable amphiphilic copolymers are especially copolymers of polyethers, N-vinylmonomers and further vinyl monomers.

Preferentially suitable are copolymers which are obtained by polymerization of vinyl acetate and N-vinyllactams in the presence of a polyether.

Corresponding copolymers are obtained by free-radically initiated polymerization of a mixture of
i) 30 to 80% by weight of N-vinyllactam,
ii) 10 to 50% by weight of vinyl acetate, and
iii) 10 to 50% by weight of a polyether,

with the proviso that the sum of components i), ii) and iii) is 100% by weight.

In one embodiment of the invention, preferred copolymers obtained from:
i) 30 to 70% by weight of N-vinyllactam,
ii) 15 to 35% by weight of vinyl acetate, and
iii) 10 to 35% by weight of a polyether are used.

Copolymers used with particular preference are obtainable from:
i) 40 to 60% by weight of N-vinyllactam,
ii) 15 to 35% by weight of vinyl acetate, and
iii) 10 to 30% by weight of a polyether.

Copolymers used with very particular preference are obtainable from
i) 50 to 60% by weight of N-vinyllactam,
ii) 25 to 35% by weight of vinyl acetate, and
iii) 10 to 20% by weight of a polyether.

For the preferred and particularly preferred compositions too, the proviso applies that the sum of components i), ii), and iii) equals 100% by weight.

Useful N-vinyllactams are N-vinylcaprolactam or N-vinylpyrrolidone or mixtures thereof. Preference is given to using N-vinylcaprolactam.

The graft bases used are polyethers. Useful polyethers are preferably polyalkylene glycols. The polyalkylene glycols may have molecular weights of 1000 to 100 000 Da [daltons], preferably 1500 to 35 000 Da, more preferably 1500 to 10 000 Da. The molecular weights are determined proceeding from the OH number measured to DIN 53240.

Particularly preferred polyalkylene glycols include polyethylene glycols. Also additionally suitable are polypropylene glycols, polytetrahydrofurans or polybutylene glycols, which are obtained from 2-ethyloxirane or 2,3-dimethyloxirane.

Suitable polyethers are also random or block copolymers of polyalkylene glycols obtained from ethylene oxide, propylene oxide and butylene oxides, for example polyethylene glycol-polypropylene glycol block copolymers. The block copolymers may be of the AB type or of the ABA type.

The preferred polyalkylene glycols also include those which are alkylated at one or both OH end groups. Useful alkyl radicals include branched or unbranched C₁- to C₂₂-alkyl radicals, preferably C₁-C₁₈-alkyl radicals, for example methyl, ethyl, n-butyl, isobutyl, pentyl, hexyl, octyl, nonyl, decyl, dodecyl, tridecyl or octadecyl radicals.

General processes for preparing the copolymers used in accordance with the invention are known per se. They are prepared by free-radically initiated polymerization, preferably in solution, in nonaqueous organic solvents or in mixed nonaqueous/aqueous solvents. Suitable preparation processes are described, for example, in WO 2007/051743 and WO 2009/013202, the disclosure of which is referred to explicitly with regard to the preparation process.

According to the invention, the formulations of sparingly soluble active ingredients embedded in amphiphilic copolymers are processed to moldings by injection molding.

It is a feature of the process that a formulation composed of amphiphilic copolymers with sparingly soluble active ingredients is used for the injection molding process. For this purpose, the mixture can be converted to a melt by heating in suitable vessels. This may also already have been carried out in a temperature-controlled reservoir vessel for the injection molding apparatus, such that the required injection temperature is ensured. The temperature of the reservoir vessel may be 60 to 260° C., preferably 90 to 200° C.

From this reservoir vessel, the melt can be transferred or injected under pressure into a suitable injection mold. The mold temperature may be 40 to 180° C., preferably 70 to 140° C. After the injection operation, the mold must then cool in order that the injection molding can be removed from the injection mold.

The injection molds may be of various configurations. It is possible to injection mold moldings in tablet form. For instance, solid drug forms which require no further process step, such as tableting, are obtainable via the injection molding process. The moldings may be cylindrical, lenticular, rhombus-shaped, triangular, quadrangular, polygonal, ellipsoidal, oval, oval with double radii, square, cushion-shaped, cartridge-shaped, arrow-shaped, barrel-shaped, almond-shaped, shield-shaped, half moon-shaped, heart-shaped, in tailored form or in combinations of these forms. It is additionally possible for the injection mold also to introduce break marks into the corresponding moldings.

In a further embodiment of the invention, the polymer melt can be produced by means of a melt extruder. For this purpose, it is possible to use single-screw extruders or twin-screw extruders. In this case, the polymer or the polymer-active ingredient mixture is metered into the extruder in pulverulent form by means of suitable metering units. The powder mixture is drawn here into the extruder by the screws. Subsequently, the mixture of the components is melted. The melt then passes into the reservoir vessel of an injection molding apparatus. The temperature in the extruder barrel is increased after passage through the intake barrel until the optimal extrusion temperature is determined. Advantageously, the extrusion temperature is equal to the temperature of the reservoir vessel and of the injection apparatus, such that the melt has homogeneous properties during the process. Suitable temperature ranges are 60 to 260° C., preferably 90 to 200° C.

One advantage of the incorporation of sparingly soluble active ingredients into the amphiphilic polymer in the course of injection molding is that the sparingly soluble active ingredient, as in the customary extrusion process, is present in amorphous form or in solid solution in the resulting matrix. The further processing to give the final tablet by means of injection molding makes the process a completely continuous production process.

In addition to the active ingredients, the formulations may comprise, for example, polymers for adjusting the glass transition temperature and the melt viscosity, disintegrants, further solubilizers, plasticizers, dyes, flavorings, sweeteners, stabilizers such as antioxidants, preservatives or wetting agents. The addition of crystallization-inhibiting substances, for example, Kollidon 30 allows the stability of the solid solutions to be increased.

In addition, it is also additionally possible to incorporate surfactants which lower the melt viscosity and hence the extrusion temperature into the formulations. These substances may also positively influence the possible crystallization. Suitable substances are, for example, Solutol HS 15, Tween 80, Cremophor RH40, docusate sodium or sodium laurylsulfate.

The moldings obtained by the process according to the invention can in principle be used in all fields in which only sparingly water-soluble or water-insoluble active ingredients are either to be used in aqueous formulations or are to display their action in an aqueous medium.

According to the invention, the term “sparingly water-soluble” also comprises virtually insoluble substances and means that, for a solution of the substance in water at 20° C. at least 30 to 100 g of water are required per g of substance. In the case of virtually insoluble substances, at least 10 000 g of water are required per g of substance.

In the context of the present invention, sparingly-water soluble substances are preferably understood to mean biologically active substances such as active pharmaceutical ingredients for humans and animals, active cosmetic or agrochemical ingredients, or food supplements or active dietetic ingredients.

In addition, useful sparingly soluble substances to be solubilized also include dyes such as inorganic or organic pigments.

According to the invention, useful biologically active substances include, in principle, all solid active ingredients which have a melting point below the decomposition point under extrusion conditions of the copolymers. The copolymers can generally be extruded at temperatures up to 260° C. The lower temperature limit is guided by the composition of the mixtures to be extruded and the sparingly soluble substances to be processed in each case.

The active pharmaceutical ingredients used are water-insoluble substances or substances with low water solubility. According to DAB 9 (Deutsches Arzneimittelbuch, German Pharmacopeia), the solubility of active pharmaceutical ingredients is classified as follows: low solubility (soluble in 30 to 100 parts of solvent); sparingly soluble (soluble in 100 to 1000 parts of solvent); virtually insoluble (soluble in more than 10 000 parts of solvent). The active ingredients may come from any indication sector.

Examples here include benzodiazepines, antihypertensives, vitamins, cytostatics—especially taxol, anesthetics, neuroleptics, antidepressants, antivirals, for example anti-HIV drugs, antibiotics, antimycotics, antidementives, fungicides, chemotherapeutics, urologics, thrombocyte aggregation inhibitors, sulfonamides, spasmolytics, hormones, immunoglobulins, sera, thyroid therapeutics, psychopharmaceuticals, Parkinson's drugs and other antihyperkinetics, ophthalmics, neuropathy preparations, calcium metabolism regulators, muscle relaxants, anesthetics, lipid-lowering drugs, liver therapeutics, coronary drugs, cardiac drugs, immunotherapeutics, regulatory peptides and inhibitors thereof, hypnotics, sedatives, gynecologicals, gout remedies, fibrinolytics, enzyme preparations and transport proteins, enzyme inhibitors, emetics, blood-flow stimulators, diuretics, diagnostics, corticoids, cholinergics, biliary therapeutics, antiasthmatics, bronchodilators, beta-receptor blockers, calcium antagonists, ACE inhibitors, arteriosclerotic drugs, anti-inflammation drugs, anticoagulants, antihypotensives, antihypoglycemics, antihypertensives, antifibrinolytics, antiepileptics, antiemetics, antidotes, antidiabetics, antiarrhythmics, antianemics, antiallergics, anthelmintics, analgesics, analeptics, aldosterone antagonists, slimming drugs.

Among the abovementioned pharmaceutical formulations, particular preference is given to those which are orally administrable formulations.

The content of amphiphilic copolymer in the pharmaceutical formulation is, depending on the active ingredient, in the range from 1 to 75% by weight, preferably 5 to 60% by weight, more preferably 5 to 50% by weight.

A further particularly preferred embodiment relates to pharmaceutical formulations in which the active ingredients and the copolymer are present as a solid solution. In this case, the removal of the solvent and the incorporation of the active substance can be effected in one process step. The weight ratio of copolymer to active ingredient here is preferably from 1:1 to 4:1, but may be up to 100:1, especially up to 15:1. The only factors are that, when used in the finished drug form, an effective amount of active ingredient is firstly present in the drug form, and the forms secondly do not become too large in the case of oral drug forms.

In addition to use in cosmetics and pharmacy, the moldings produced in accordance with the invention are also suitable for use in the foods sector, for example, for the incorporation of sparingly water-soluble or water-insoluble nutrients, assistants or additives, for example, fat-soluble vitamins or carotenoids. Examples include drinks colored with carotenoids.

The use of the formulations obtained in accordance with the invention in agrochemistry may include formulations which comprise pesticides, herbicides, fungicides or insecticides, and in particular also those formulations of crop protection compositions which are used as formulations for spraying or watering.

With the aid of the process according to the invention, it is possible in a simple manner to obtain various kinds of moldings from so-called solid solutions comprising sparingly soluble substances. Solid solutions refer in accordance with the invention to systems in which no crystalline components of the sparingly soluble substance are observed.

On visual assessment of the stable solid solutions, no amorphous constituents are evident. The visual assessment can be effected with a light microscope either with or without a polarization filter at 40-fold magnification.

In addition, the formulations can also be examined for crystallinity or amorphicity with the aid of XRD (X-ray diffraction) and DSC (differential scanning calorimetry).

The formulations obtained by the process according to the invention are, as stated, present in amorphous form which means that the crystalline components of the biologically active substance are less than 5% by weight. The amorphous state is preferably checked by means of DSC or XRD. Such an amorphous state can also be referred to as an X-ray amorphous state.

The process according to the invention allows the production of stable formulations with a high active ingredient loading and good stability with regard to the amorphous state of the sparingly soluble substance.

In view of the relatively high molecular weights of the polymers used, it was unexpected that moldings can be obtained by injection molding in a simple and reliable manner.

### EXAMPLES

Preparation of the Amphiphilic Polymer

In a stirred apparatus, the initial charge without the portion from feed 2 was heated to 77° C. under an N2atmosphere. When the internal temperature of 77° C. had been attained, the portion from feed 2 was added and partly polymerized for 15 min. Subsequently, feed 1 was metered in within 5 h and feed 2 within 2 h. Once all feeds had been metered in, the reaction mixture was polymerized for a further 3 h. After the further polymerization, the solution was adjusted to a solids content of 50% by weight.

Initial charge:
25 g of ethyl acetate
104.0 g PEG 6000,
1.0 g of feed 2

Feed 1:
240 g of vinyl acetate
456 g of vinylcaprolactam
240 g of ethyl acetate

Feed 2:
10.44 g of tert-butyl perpivalate (75% by weight in aliphatics mixture)
67.90 g of ethyl acetate

Subsequently, the solvent was removed by a spray process to obtain a pulverulent product. The K value was 36, measured in 1% by weight solution in ethanol.

Production of the moldings

Conical twin-screw extruder:

Haake MiniLab, Thermo Fisher, Karlsruhe, Germany

Injection molding unit:

HAAKE MiniJet System, Thermo Fisher, Karlsruhe, Germany

The twin-screw extruder was operated at 50 rpm without actuating the bypass option. The injection pressure of the injection molding unit was kept constant at 8 bar. The injection mold was always cooled to room temperature before the molding was removed. The injection mold was designed so as to result in cylindrical moldings: diameter 4 cm, average thickness 3 mm.

The moldings produced were analyzed by means of XRD and DSC for crystallinity and amorphicity using the following equipment and conditions:

XRD

Instrument: D 8 Advance diffractometer with 9-tube sample changer (from Bruker/AXS)

Measurement method: θ-θ geometry in reflection

Angle range 2 theta: 2-80°

Step width: 0.02°

Measurement time per angle step: 4.8 s

Divergence slit: Göbel mirror with 0.4 mm inserted aperture

Antiscattering slit: Soller slit

Detector: Sol-X detector

Temperature: room temperature

Generator setting: 40 kV/50 mA

DSC

DSC Q 2000 from TA Instruments

Parameters:

Starting weight approx. 8.5 mg

Heating rate: 20K/min

The active ingredient release was measured according to USP (paddle method) 2, 37° C., 50 rpm (BTWS 600, Pharmatest). The active ingredient released was detected by UV spectroscopy (Lamda-2, Perkin Elmer).

### EXAMPLES

### Example 1

10 g of polymer and 4 g of cinnarizine (melting point 122° C.) were premixed manually with a mortar and pestle.

The mixture was processed with the following parameters:
extruder temperature: 140° C.
screw speed 50 rpm
reservoir vessel temperature: 140° C.
mold temperature: 120° C.

The moldings were analyzed by XRD and by DSC and were found to be amorphous. The finished moldings were also used for the release without any further preparation. After 1 h in 0.1 normal HCl, 100% active ingredient had been released.

### Example 2

10 g of polymer and 4 g of fenofibrate (melting point 81° C.) were premixed manually with a mortar and pestle.

The mixture was processed with the following parameters:
extruder temperature: 120° C.
screw speed 50 rpm
reservoir vessel temperature: 120° C.
mold temperature: 95° C.

The moldings were analyzed by XRD and by DSC and were found to be amorphous. The finished moldings were also used for the release without any further preparation. After 1 h in demineralized water, 95% active ingredient had been released.

### Example 3

10 g of polymer and 4 g of itraconazole (melting point 166° C.) and 2 g of Lutrol F68 were premixed manually with a mortar and pestle.

The mixture was processed with the following parameters:
extruder temperature: 170° C.
screw speed 50 rpm
reservoir vessel temperature: 170° C.
mold temperature: 130° C.

The moldings were analyzed by XRD and by DSC and were found to be amorphous. The finished moldings were also used for the release without any further preparation. After 0.5 h in 0.1 normal HCl, 40% active ingredient had been released.

### Example 4

8 g of polymer and 3 g of danazole (melting point 225° C.) and 2 g of sodium lauryl sulfate were premixed manually with a mortar and pestle.

The mixture was processed with the following parameters:
extruder temperature: 180° C.
screw speed 50 rpm
reservoir vessel temperature: 180° C.
mold temperature: 150° C.

The moldings were analyzed by XRD and by DSC and were found to be amorphous. The finished moldings were also used for the release without any further preparation. After 0.5 h in pH 7 phosphate buffer, 50% active ingredient had been released.

### Example 5

10 g of polymer and 5 g of carbamazepine (melting point 192° C.) and 5 g of PEG 1500 were premixed manually with a mortar and pestle.

The mixture was processed with the following parameters:
extruder temperature: 165° C.
screw speed 50 rpm
reservoir vessel temperature: 165° C.
mold temperature: 120° C.

The moldings were analyzed by XRD and by DSC and were found to be amorphous. The finished moldings were also used for the release without any further preparation. After 1 h in 0.1 normal HCl, 73% active ingredient had been released.

### Example 6

10 g of polymer and 3 g of clotrimazole (melting point 145° C.) were premixed manually with a mortar and pestle.

The mixture was processed with the following parameters:
extruder temperature: 160° C.
screw speed 50 rpm
reservoir vessel temperature: 160° C.
mold temperature: 120° C.

The moldings were analyzed by XRD and by DSC and were found to be amorphous. The finished moldings were also used for the release without any further preparation. After 1 h in demineralized water, 65% active ingredient had been released.

### Example 7

12 g of polymer and 4.5 g of piroxicam (melting point 199° C.) were premixed manually with a mortar and pestle.

The mixture was processed with the following parameters:
extruder temperature: 170° C.
screw speed 50 rpm
reservoir vessel temperature: 170° C.
mold temperature: 140° C.

The moldings were analyzed by XRD and by DSC and were found to be amorphous. The finished moldings were also used for the release without any further preparation. After 0.5 h in pH 4.5 acetate buffer, 55% active ingredient had been released.

1. A process for producing moldings from formulations of a sparingly water-soluble active ingredient embedded in amphiphilic copolymers, which comprises shaping the formulations by injection-molding a melt of the formulations at a mold temperature of the melt in the range of 40 to 180° C.

2. The process of claim 1, wherein the amphiphilic copolymer is obtained by free-radically initiated polymerization of a mixture of
i) 30 to 80% by weight of N-vinyllactam,
ii) 10 to 50% by weight of vinyl acetate, and
iii) 10 to 50% by weight of a polyether,
with the proviso that the sum of components i), ii) and iii) is 100% by weight, wherein the sparingly water-soluble substance active ingredient is embedded into the copolymer at temperatures above the melting point of the sparingly soluble substances.

3. The process of claim 2, wherein the amphiphilic copolymer is obtained from
i) 30 to 70% by weight of N-vinyllactam,
ii) 15 to 35% by weight of vinyl acetate, and
iii) 10 to 35% by weight of a polyether are used.

4. The process of claim 2, wherein the N-vinyllactam comprises N-vinylpyrrolidone or N-vinylcaprolactam or a mixture thereof.

5. The process of claim 2, wherein the N-vinyllactam comprises N-vinylcaprolactam.

6. The process of claim 2, wherein the polyether comprises polyethylene glycol.

7. The process of claim 2, wherein the polyether comprises a polyethylene glycol with a molecular weight of 1000 daltons to 10 000 daltons.

8. The process of claim 1, wherein the amphiphilic copolymers have a K value of 10 to 60.

9. The process according to any one of claim 1, wherein the amphiphilic copolymers have a K value of 15 to 40.

10. The process of claim 1, wherein the mold temperature of the melt is 70 to 140° C.

11. The process of claim 1, wherein the melt is supplied to the an injection molding apparatus via a reservoir vessel.

12. The process of claim 11, wherein the reservoir vessel is at a temperature of 60 to 260° C.

13. The process of claims 12, wherein the reservoir vessel temperature is 90 to 200° C.

14. The process of claim 1 for producing pharmaceutical preparations for the treatment of disorders.

15. The process of claim 1 for producing cosmetic formulations.

16. The process of claim 1 for producing food supplements or dietetic compositions.

17. The process of claim 1 for producing formulations of dyes.

18. The process of claim 1, wherein the melt of the formulations is produced in a melt extruder.

19. The process of claim 1, wherein the sparingly water-soluble active ingredient is embedded in the amphiphilic copolymers at temperatures of up to 260° C.

20. The process of claim 1, wherein agents which prevent the recrystallization of the active ingredients are added to the formulations.
